(19) United States
(12) Patent Application Publication
(10) Pub. No.: US 2011/0296797 A1
(43) Pub. Date: Dec. 8, 2011

(54) TWO-PIECE HERMETIC SEAL BELLOWS FOR SINGLE-SIDE PLACEMENT ON AN INSULATING GLASS UNIT OR HIGHLY INSULATING VACUUM GLASS UNIT

(76) Inventors: DAVID H. STARK, EVERGREEN, CO (US); LAWRENCE J. MOTT, CALHAN, CO (US)

(21) Appl. No.: 13/152,249

(22) Filed: Jun. 2, 2011

Related U.S. Application Data
(60) Provisional application No. 61/350,873, filed on Jun. 2, 2010.

(51) Int. Cl. E06B 7/16; E04C 2/34

(52) U.S. Cl. 52/788.1

(57) ABSTRACT

A vacuum insulating glazing unit (VIGU) comprises a first glass pane and a second glass pane spaced-apart from the first pane to define a cavity therebetween. A first seal member is bonded at a first end to the first glass pane and a second seal member is bonded at a first end to the second glass pane and at a second end to a second end of the first glass pane. At least one of the first seal member and the second seal member has a configuration (when viewed parallel to the panes) including at least one of a toward-pane oriented convolute and an away-from-pane oriented convolute.

### CROSS-REFERENCE TO RELATED APPLICATIONS

This application claims benefit of U.S. Provisional Application No. 61/350,873, filed Jun. 2, 2010, and entitled TWO-PIECE HERMETIC SEAL BELLOWS FOR SINGLE-SIDE PLACEMENT ON AN INSULATING GLASS UNIT OR HIGHLY INSULATING VACUUM GLASS UNIT (Atty. Dkt. No. STRK-30,074).

### TECHNICAL FIELD

The following disclosure relates to insulating windows and glazing products. More particularly, it relates to vacuum insulating glazing units with multiple transparent panes having an evacuated space therebetween.

### BACKGROUND

Using vacuum to increase the insulating performance of window glazing components is not a new concept, and in fact many innovative approaches have been taught in the literature over the last 75 years. It is, however, readily observed by skilled practitioners of the art that the majority of the prior work relates to low- to medium-vacuum levels, i.e., vacuum levels within the range from about 760 torr to about 10⁻³ torr. Note, for purposes of this application, a “higher” level of vacuum is understood to correspond to a lower absolute pressure, e.g., a vacuum level of 10⁻⁴ torr is a higher vacuum than 10⁻³ torr. In a few cases, the literature makes reference to the measured vacuum levels in glazing components, but in many cases the maintainable vacuum level must be interpreted from careful evaluation of the materials exposed to the vacuum enclosure, the methods used to create the vacuum seal and the methods used to produce the vacuum condition in the enclosed space.

While the literature describing vacuum insulating window glazing components may not rigorously define the vacuum levels, literature from other industries, such as the electronics industry, defines different vacuum levels and the types of materials and processing methods required to achieved and maintain those specified vacuum levels. The common distinction between medium- and high-vacuum devices is a vacuum level of 10⁻³ torr. In other words, the range of high-vacuum levels begins at about 10⁻³ torr and goes higher, i.e., in the direction toward and/or past 10⁻⁴ torr. In the case of vacuum insulating window glazing components, where it is desirable for the components to retain a prescribed minimum vacuum level for an extended operating lifetime (e.g., 25 years), a vacuum containment system capable of initially maintaining a higher level of vacuum (e.g., 10⁻⁵ torr), may be necessary. For the purposes of this application, vacuum insulating glazing units capable of maintaining vacuum levels of 10⁻³ torr or higher are termed high-vacuum insulating glazing units (HVIGU).

One purpose of HVIGUs is to provide lower levels (i.e., compared to units with low or medium-vacuum levels) of conductive heat losses between temperature-controlled spaces and non-temperature-controlled spaces separated by the glazing unit. In such cases providing this desired lower level of conductive heat loss over a long period of time is desirable. Since the ambient conditions in the uncontrolled space, most commonly the external atmospheric environment, produce a variety of stresses, including thermal, pressure and mechanical vibration and since, to a lesser extent, this also happens also in the conditioned space, various embodiments of the HVIGU will be more or less capable of surviving the applied stresses while maintaining the desired minimum vacuum level. Thus, the design lifetime, i.e., the period of time that the HVIGU will maintain its level of performance, is one of the performance features of the HVIGU.

Generally speaking, HVIGUs are typically constructed using at least two spaced-apart panes of glass of some prescribed thickness. These glass panes are then sealed, typically along the edges, using some arrangement of sealing elements, which are intended to isolate the evacuated volume from the surrounding atmospheric pressure. Since the primary objective of the HVIGU is to provide a low thermally-conductive barrier between environmental spaces, each of which may have a higher or lower temperature with respect to the other, it is obvious to skilled practitioners of the art that the two panes of glass may reach temperature levels which vary distinctly from each other. In fact, for a given space-to-space temperature differential, the pane-to-pane temperature differential will typically increase as a function of reduced thermal conductivity of the HVIGU. As a result of the temperature differential between the panes of glass, the panes may expand and contract differentially. This may introduce substantial strain at the edges of the HVIGU where the seal is attached. If the seal at the HVIGU edge is made to be rigid, pane-to-pane temperature differentials may produce significant stresses in the HVIGU, along with a number of expected deleterious effects, for example, large-scale deflections, bowing and other physical or optical changes of panes and/or shortened seal life for the HVIGU.

A need exists, therefore, for a flexible edge seal for a HVIGU or other insulated glazing unit that can accommodate the strains associated with the expanding and contracting glass panes. A need further exists, for a flexible edge seal that can withstand the mechanical forces imposed by atmospheric pressure on the seal. A need still further exists, for a flexible edge seal that can retain the prescribed vacuum levels within the evacuated space.

### SUMMARY

In one aspect, the invention comprises a flexible edge seal for a vacuum insulating glazing unit having a first glass pane and a second glass pane spaced-apart from the first. The edge seal comprises a seal member formed of a hermetically bondable material and having a first end, a second end and a center section disposed therebetween. The first end is hermetically bondable to a first glass pane. The second end is hermetically bondable to a second glass pane. The center section comprises a one or more convolutes.

In a second aspect, the invention comprises a flexible edge seal for a vacuum insulating glazing unit having a first glass pane and a second glass pane spaced-apart from the first. The edge seal comprises a seal member formed of a hermetically bondable material and having a first end, a second end and a center section disposed therebetween. The first end is hermetically bondable to a first glass pane. The second end is hermetically bondable to a second glass pane. The center section of one seal member comprises a one or more convolutes. The center section of the second seal member is straight and parallel to the glass pane.

In another aspect, a vacuum insulating glazing unit (VIGU) comprises a first glass pane and a second glass pane spaced-apart from the first pane to define a cavity therebetween. A first seal member is bonded at a first end to the first glass pane and a second seal member is bonded at a first end to the second glass pane and at a second end to a second end of the first glass pane. At least one of the first seal member and the second seal member has a configuration (when viewed parallel to the panes) including at least one of a toward-pane oriented convolute and an away-from-pane oriented convolute.

In another aspect of the VIGU, both the first seal member and the second seal member each has a configuration (when viewed parallel to the panes) including at least one of a toward-pane oriented convolute and an away-from-pane oriented convolute.

In another aspect of the VIGU, at least one convolutes of one of the seal members is nested within a like-oriented convolute of the other seal member.

### BRIEF DESCRIPTION OF THE DRAWINGS

For a more complete understanding, reference is now made to the following description taken in conjunction with the accompanying Drawings in which:

FIG. 1 illustrates an IGU, VIGU or HVIGU with a two-piece bellows in which both pieces contain convolutes and nest within each other in accordance with one embodiment;

FIG. 2 illustrates an IGU, VIGU or HVIGU with a two-piece bellows in accordance with another embodiment in which one piece contains convolutes and the second piece lays flat;

FIG. 3 illustrates an IGU, VIGU or HVIGU with a two-piece bellows in accordance with another embodiment in which the tangent(s) of the radius of the convolute of one piece contact flat section(s) of the other piece; and

FIG. 4 illustrates an IGU, VIGU or HVIGU with a two-piece bellows in accordance with another embodiment in which the lower surface of the upper piece and the upper surface of the lower piece are in near or complete contact with each other for most of their length.

### DETAILED DESCRIPTION

Referring now to the drawings, wherein like reference numbers are used herein to designate like elements throughout, the various views and embodiments of a two-piece hermetic seal bellows for single-side placement on an insulating glass unit or highly insulating vacuum glass unit are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

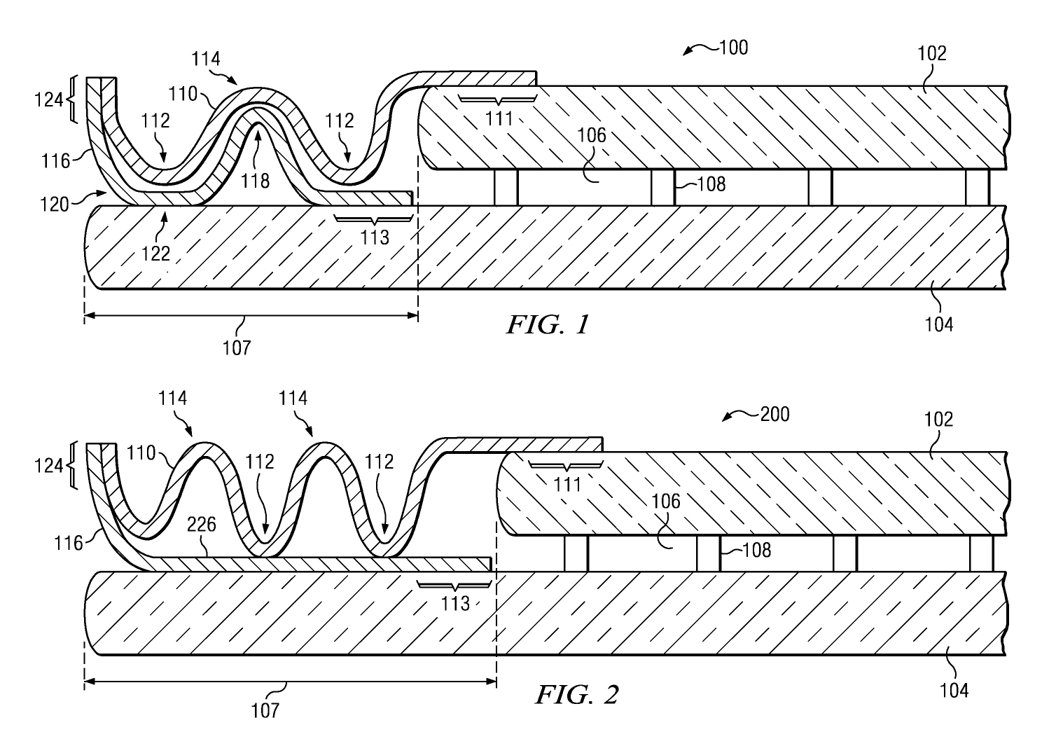

FIGS. 1, 2, 3 and 4 show a two-piece bellows in which one end of each piece (shown as the right-side or right-end of each piece in the figures) is hermetically bonded to one of the two glass panes of the IGU, VIGU or HVIGU, and the second end of each piece (shown as the left-side or left-end of each piece in the figures) is not bonded or attached to either of the two glass panes of the IGU, VIGU or HVIGU. The hermetic seal is made by hermetically sealing the two seal members together at the left-side or left-end of each piece (seal member) by an appropriate means such as hermetically welding on bonding them together. Although the figures are two-dimensional, in actuality, the two-piece bellows is attached to the two glass panes around the entire perimeter of the two glass units in order to form a complete hermetic seal of the two glass pane.

FIGS. 1, 2 and 4 show a two-piece bellows unit in which both seal members contain one or more convolutes. In addition, the convolute(s) of one seal member may be nested inside a partial or complete convoluted section of the second seal member. The convolutes act as a spring component, allowing movement of one glass pane relative to the other glass pane that results when the two panes expand or contract with changes in temperature. In addition, the spring-like form of the bellows allows this relative movement of the two glass panes to occur with a much-reduced stress transferred from one glass pane to the other as compared to a rigid edge seal such as occurs with a solder glass or sealing glass seal. Furthermore, the bellows are highly hermetic, meaning that they prevent almost any permeation of gasses through the seal members, whereas traditional multi-pane IGUs have spacers in between pairs of glass panes at the perimeter of the panes, such spacers being held in place with an adhesive bond and sometime further sealed along the outside surfaces of the IGU with a sealant. No adhesive or sealant know today is highly hermetic or highly impervious to the permeation of many types of gases, including helium, argon, krypton and xenon. Thus, no IGU, VIGU or HVIGU could maintain an internal pressure or 10⁻³ torr for 10 years or more using an adhesive with or without a sealant to bond a spacer between the two panes of glass or to bond the bellows shown in FIGS. 1 through 4 to the two panes of glass. The bond of the seal units of the bellows must be bonded to the panes of glass by a means that provides a highly hermetic seal capable of maintaining an internal pressure of no greater than 10⁻³ torr for 10 years or more when the initial or starting pressure when the bellows' seals are joined together is at or below (less than) 10⁻³ torr.

Referring now to FIG. 1, there is illustrated an IGU, VIGU or HVIGU (hereafter, collectively referred to as “VIGU”) with a two-piece seal (or bellows) in accordance with one embodiment. In this embodiment, both pieces of the bellows contain convolutes and nest within each other. VIGU 100 comprises a first glass pane (or lite) 102 and a second glass pane 104 that is spaced apart from the first pane to define a cavity 106 therebetween. In some embodiments, the edges of the panes 102, 104 are parallel, but in other embodiments (such as the one shown in FIG. 1) one pane extends past the other to form an overhanging region (denoted 107). In preferred embodiments, the convolutes of the seal/bellows are disposed in the overhang region 107. In some embodiments, a plurality of stand-off members 108 is disposed within the cavity 106 to maintain the separation of the panes 102, 104.

Referring still to FIG. 1, each seal/bellows member of VIGU 100 is bonded to the surface of the respective glass panes 102, 104 to form a hermetic seal. The seal/bellows comprises a first seal member 110 bonded to the first glass pane 102 in a first bonding region (denoted 111) and a second seal member 116 bonded to the second glass pane 104 in a second bonding region (denoted 113). In a preferred embodiment, the bonding regions 111 and 113 are both disposed on the same-facing sides of the respective glass panes 102 and 104. The first seal member 110 has a configuration (when viewed parallel to the panes) including one or more toward-pane oriented convolutes 112 and/or away-from-pane oriented convolutes 114. The second seal member 116 has a configuration (when viewed parallel to the panes) including one or more away-from-pane oriented convolutes 118 and/or toward-pane oriented convolutes 120. Some of the toward-pane oriented convolutes on the second seal member 116 may include substantially flat regions 122. At least some of the toward-pane oriented convolutes 112 of the first member 110 are “nested” within the toward-pane oriented convolutes 120 of the second member 116 and/or at least some of the away-from-pane oriented convolutes 118 of the second member 116 are “nested” within the away-from-pane oriented convolutes 114 of the first member 110. Further, some of the toward-pane convolutes 112 of the first seal member 110 may come into contact with the flat regions 122 of the second seal member 116. The flat sections of the bottom seal 116 that may contact the second glass pane 104 provide a large area of contact that minimizes concentrated abrasion on the bottom glass pane and also provides a large surface area on which the convolutes 112 of the first seal member 110 can slide as the two panes expand and contract differentially.

The seal members 110 and 116 are bonded to one another in a third bonding region (denoted 124), typically located at the end of the seal members opposite those bonded to the glass panes 102 and 104. The bonding of the seal members may be accomplished by welding, soldering or other metal joining processes known to produce a hermetic seal. Once the bonds in regions 110, 113 and 124 are complete, the cavity 106 will be hermetically sealed (notwithstanding any pump-out tubes or other deliberate openings used for further processing).

Referring now to FIG. 2, there is illustrated another VIGU with a two-piece seal/bellows in accordance with another embodiment. In this embodiment, one seal member includes convolutes and the second seal member lays flat (i.e., parallel to the surface of the glass pane) and does not have convolutes. VIGU 200 is substantially similar to VIGU 100 in most respects, e.g., it comprises a first glass pane 102 and a second glass pane 104 that is spaced apart from the first pane to define a cavity 106 therebetween. The convolutes of the seal/bellows may be disposed in an overhang region 107. A plurality of stand-off members 108 may be disposed within the cavity 106 to maintain the separation of the panes 102, 104.

Referring still to FIG. 2, each seal/bellows member of VIGU 200 is bonded to the surface of the respective glass panes 102, 104 to form a hermetic seal. The seal/bellows comprises a first seal member 110 bonded to the first glass pane 102 in a first bonding region (denoted 111) and a second seal member 116 bonded to the second glass pane 104 in a second bonding region (denoted 113). In a preferred embodiment, the bonding regions 111 and 113 are both disposed on the same-facing sides of the respective glass panes 102 and 104. The first seal member 110 has a configuration (when viewed parallel to the panes) including one or more toward-pane oriented convolutes 112 and/or away-from-pane oriented convolutes 114. The second seal member 116 has a configuration (when viewed parallel to the panes) which does not include convolutes, but includes a flat region 226 lying parallel to the glass pane 104. Some of the toward-pane convolutes 112 of the first seal member 110 may come into contact with the flat region 226 of the second seal member 116. The second seal member 116 is designed to be flat and parallel for most of its length, with the exception of the portion 124, where it is hermetically bonded, sealed or welded to the first (convoluted) seal member 110. The flat section 226 that may contact the bottom glass pane 104 provides a large area of contact that minimizes concentrated abrasion on the bottom glass pane and also provides a large surface area on which the convolutes 112 of the first seal member 110 can slide as the two panes 102, 104 expand and contract differentially.

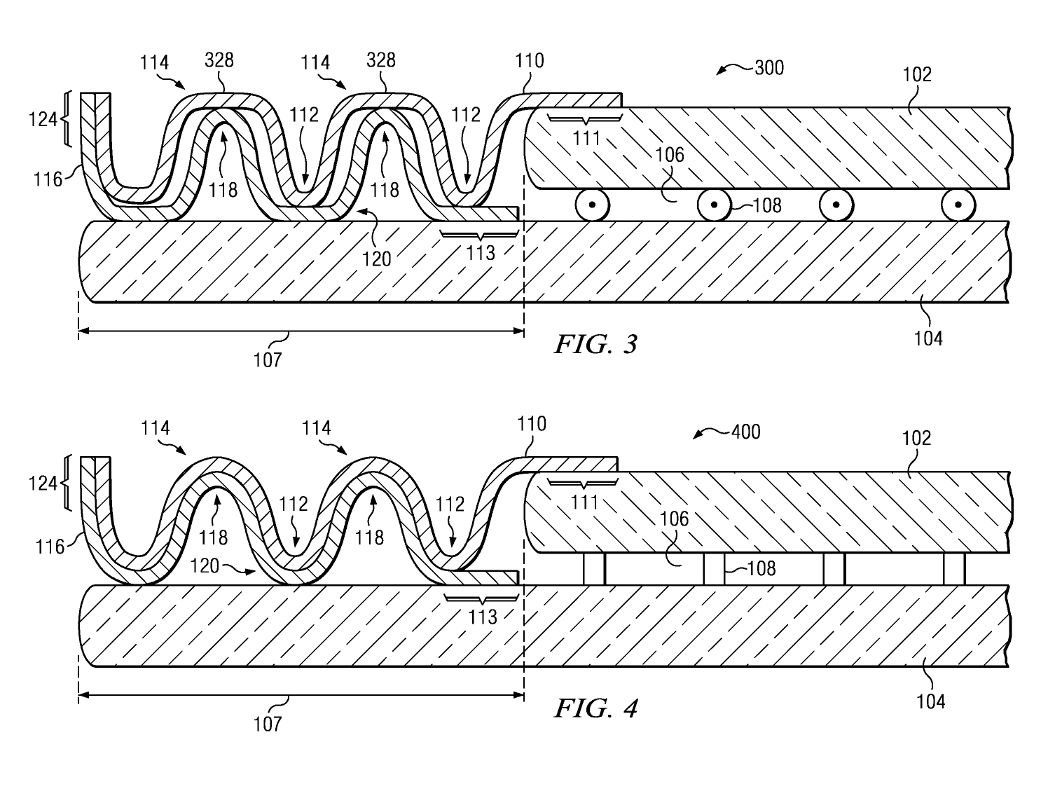

Referring now to FIG. 3, there is illustrated another VIGU with a two-piece seal/bellows in accordance with another embodiment. In this embodiment, both seal members includes convolutes and some of the convolutes nest within other convolutes. VIGU 300 is substantially similar to VIGUs 100 and 200 in most respects, e.g., it comprises a first glass pane 102 and a second glass pane 104 that is spaced apart from the first pane to define a cavity 106 therebetween. The convolutes of the seal/bellows may be disposed in an overhang region 107. A plurality of stand-off members 108 may be disposed within the cavity 106 to maintain the separation of the panes 102, 104.

Referring still to FIG. 3, each seal/bellows member of VIGU 300 is bonded to the surface of the respective glass panes 102, 104 to form a hermetic seal. The seal/bellows comprises a first seal member 110 bonded to the first glass pane 102 in a first bonding region (denoted 111) and a second seal member 116 bonded to the second glass pane 104 in a second bonding region (denoted 113). In a preferred embodiment, the bonding regions 111 and 113 are both disposed on the same-facing sides of the respective glass panes 102 and 104. The first seal member 110 has a configuration (when viewed parallel to the panes) including one or more toward-pane oriented convolutes 112 and/or away-from-pane oriented convolutes 114. The second seal member 116 has a configuration (when viewed parallel to the panes) including one or more away-from-pane oriented convolutes 118 and/or toward-pane oriented convolutes 120. Some of the toward-pane oriented convolutes 120 on the second seal member 116 may include substantially flat regions 322. Some of the away-from-pane oriented convolutes 114 on the first seal member 110 may include substantially flat regions 328. At least some of the toward-pane oriented convolutes 112 of the first member 110 are “nested” within the toward-pane oriented convolutes 120 of the second member 116 and/or at least some of the away-from-pane oriented convolutes 118 of the second member 116 are “nested” within the away-from-pane oriented convolutes 114 of the first member 110. Further, some of the away-from-pane convolutes 118 of the second seal member 116 may come into contact with the flat regions 328 of the first seal member 110 and/or some of the toward-pane convolutes 112 of the first seal member 110 may come into contact with the flat regions 322 of the second seal member 116. In the embodiment of FIG. 3, each seal member 110, 116 has relatively narrow convolutes (e.g., 112, 118) and relatively wide convolutes (e.g., 114, 120), and all the relatively narrow convolutes are nested within and contacting the relatively flat portions (e.g., 322, 328) of wide convolutes of the opposing seal member. This configuration may provide a large surface area for the tightly-radiused convolutes to move or slide against the adjacent seal member's surface.

Referring now to FIG. 4 there is illustrated another VIGU with a two-piece seal/bellows in accordance with another embodiment. In this embodiment, both seal members include convolutes that are allowed to come into near or complete contact with each other for most of the length of the bellows unit. VIGU 400 is substantially similar to VIGUs 100, 200 and 300 in most respects, e.g., it comprises a first glass pane 102 and a second glass pane 104 that is spaced apart from the first pane to define a cavity 106 therebetween. The convolutes of the seal/bellows may be disposed in an overhang region 107. A plurality of stand-off members 108 may be disposed within the cavity 106 to maintain the separation of the panes 102, 104.

Referring still to FIG. 4, each seal/bellows member of VIGU 400 is bonded to the surface of the respective glass panes 102, 104 to form a hermetic seal. The seal/bellows comprises a first seal member 110 bonded to the first glass pane 102 in a first bonding region (denoted 111) and a second seal member 116 bonded to the second glass pane 104 in a second bonding region (denoted 113). In a preferred embodiment, the bonding regions 111 and 113 are both disposed on the same-facing sides of the respective glass panes 102 and 104. The first seal member 110 has a configuration (when viewed parallel to the panes) including one or more toward-pane oriented convolutes 112 and/or away-from-pane oriented convolutes 114. The second seal member 116 has a configuration (when viewed parallel to the panes) including one or more away-from-pane oriented convolutes 118 and/or toward-pane oriented convolutes 120. At least some of the toward-pane oriented convolutes 112 of the first member 110 are “nested” within the toward-pane oriented convolutes 120 of the second member 116 and/or at least some of the away-from-pane oriented convolutes 118 of the second member 116 are “nested” within the away-from-pane oriented convolutes 114 of the first member 110. In the embodiment of FIG. 4, the convolutes of both seal member 110, 116 are allowed to come into near or complete contact with each other for most of the length of the bellows, except for the portions 111, 113 where the seal members are hermetically bonded to the respective glass panes 102, 104. This configuration may provide the most bellows compliancy in the shortest length, all other factors being held constant, such as seal member thickness, seal material used, the total length of the bellows from the end of the seal joining (portion denoted 124) to the glass-to-metal bond regions 111, 113. In practice, although both seal members are shown to be in contact with each other along all but their right sides, they may in fact be in contact in some but not all portions of their lengths.

When the IG, VIG or HVIG is used as a glass component for windows for buildings, it is most often a type of soda-lime glass. The material of the bellows (typically metal) should match the thermal coefficient of expansion (CTE or TCE) of the soda-lime glass within 1 part per million per degree centigrade (1 ppm/0 C) or closer, so that the stress in the glass to bellows bond is not significant during thermal excursions of the glass and the glass-bond region. Otherwise, the stress in the glass-to-bellows bond region might become high enough to cause damage to the IGU, VIGU or HVIGU, including failure of the bond or an adjacent region of the insulating glass unit.

Although the bellows' sealing region may be sealed with the IGU, VIGU or HVIGU in the end-item assembly in a vacuum of the desired initial pressure for the assembled unit, an alternative method of reducing the pressure in the cavity created by the two panes of glass and the attached bellows, is to provide a pressure evacuation septum on one of the two seal members of the bellows and, after the bellows' seal members are hermetically attached to their intended panes of glass and the bellows is hermetically sealed shut, to evacuate the VIG or VIGU by connecting the septum to a pressure evacuation system and evacuating the now-sealed VIGU or HVIGU until the desired level of vacuum (low internal pressure) is achieved. Then the septum would itself be sealed shut and the evacuation system's connection to the septum would be removed from the septum remaining as part of the bellows.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A vacuum insulating glazing unit (VIGU) comprising:
a first glass pane;
a second glass pane spaced-apart from the first pane to define a cavity therebetween;
a first seal member bonded at a first end to the first glass pane;
a second seal member bonded at a first end to the second glass pane and at a second end to a second end of the first glass pane;
wherein at least one of the first seal member and the second seal member has a configuration (when viewed parallel to the panes) including at least one of a toward-pane oriented convolute and an away-from-pane oriented convolute.

2. A VIGU in accordance with claim 1, wherein both the first seal member and the second seal member each has a configuration (when viewed parallel to the panes) including at least one of a toward-pane oriented convolute and an away-from-pane oriented convolute.

3. A VIGU in accordance with claim 2, wherein at least one convolutes of one of the seal members is nested within a like-oriented convolute of the other seal member.
